(19) United States
(12) Patent Application Publication
(10) Pub. No.: US 2006/0197448 A1
(43) Pub. Date: Sep. 7, 2006

(54) Plasma display panel

(75) Inventors: Sang-Hun Jang, Suwon-si (KR); Hyoung-Bin Park, Suwon-si (KR); Seung-Hyun Son, Suwon-si (KR); Hidekazu Hatanaka, Suwon-si (KR); Young-Mo Kim, Suwon-si (KR); Sung-Soo Kim, Suwon-si (KR); Gi-Young Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/358,133

(22) Filed: Feb. 22, 2006

(30) Foreign Application Priority Data
Mar. 7, 2005 (KR) 10-2005-0018747

(51) Int. Cl. H01J 17/49

(52) U.S. Cl. 313/582

(57) ABSTRACT

A plasma display panel includes a first substrate and a second substrate facing each other and a plurality of barrier ribs partitioning a space therebetween to form a plurality of discharge cells. Address electrodes are arranged on the first substrate, and a plurality of first sustain electrodes and a plurality of second sustain electrodes are arranged between the second substrate and the barrier ribs to cause a surface discharge inside the discharge cells. The first sustain electrodes and the second sustain electrodes are arranged at locations corresponding to locations of the barrier ribs.

### CROSS-REFERENCE TO RELATED APPLICATION

This application claims priority to and the benefit of Korean Patent Application No. 10-2005-0018747, filed on Mar. 7, 2005, which is hereby incorporated by reference for all purposes as if fully set forth herein.

### BACKGROUND OF THE INVENTION

1. Field of the Invention

The present invention relates to a plasma display panel (PDP), and more particularly, to a brighter and more efficient PDP capable of displaying high quality images.

2. Discussion of the Background

Generally, in a plasma display panel (PDP), an alternating current (AC) or direct current (DC) voltage is applied between electrodes to cause a plasma discharge. The plasma discharge generates ultraviolet light that excites a phosphor material to emit visible light, thereby forming an image.

PDPs may be DC or AC PDPs according to discharge type. All electrodes in a DC PDP are exposed in a discharge space, and electric charges move directly between the electrodes during discharge. On the other hand, a dielectric layer covers at least one electrode of an AC PDP, and discharge is carried out by wall charges.

PDPs may also be facing discharge or surface discharge PDPs according to electrode arrangement. A facing discharge PDP includes a pair of sustain electrodes that are respectively formed on an upper substrate and lower substrate, and discharge occurs perpendicular to the substrates. A surface discharge PDP includes a pair of sustain electrodes that are formed on the same substrate, and discharge occurs parallel to the substrate. While the facing discharge PDP may be brighter and more efficient than the surface discharge PDP, a phosphor layer included in the facing discharge PDP easily deteriorates. Consequently, the surface discharge PDP is more commonly used.

FIG. 1 is an exploded perspective view showing a conventional surface discharge PDP, and FIG. 2 is a cross-sectional view of the PDP of FIG. 1.

Referring to FIG. 1 and FIG. 2, the PDP includes a lower substrate 10 and an upper substrate 20 facing each other with a discharge space therebetween. Plasma discharge occurs in the discharge space.

A plurality of address electrodes 11 are formed on the lower substrate 10, and a is first dielectric layer 12 covers the address electrodes 11. A plurality of barrier ribs 13, which are disposed at regular intervals, partition the discharge space to define a plurality of discharge cells 14. The barrier ribs 13 also prevent electrical and optical cross-talk between adjacent discharge cells 14. A discharge gas, which may be a combination of Ne gas and Xe gas, fills the discharge cells 14, and a phosphor layer 15 is coated to a predetermined thickness on the first dielectric layer 12 and sides of the barrier ribs 13, thus forming the inner wall of the discharge cells 14.

The upper substrate 20 is transparent so that it may transmit visible light, and it is usually made of glass. The upper substrate 20 is coupled with the lower substrate 10, on which the barrier ribs 13 may be formed. Pairs of first and second sustain electrodes 21a and 21b are formed on the upper substrate 20 and disposed perpendicular to the address electrodes 11. The first and second sustain electrodes 21a and 21b are formed of a transparent conductive material, such as indium tin oxide (ITO), so that they may transmit visible light. In order to reduce the line resistance of the first and second sustain electrodes 21a and 21b, narrower metallic first and second bus electrodes 22a and 22b are formed on the first and second sustain electrodes 21a and 21b, respectively. A transparent second dielectric layer 23 covers the first and second sustain electrodes 21a and 21b and the first and second bus electrodes 22a and 22b, and a protective layer 24 covers the second dielectric layer 23. The protective layer 24 prevents plasma sputtering from damaging the second dielectric layer 23, and it emits secondary electrons, thereby lowering a discharge voltage. The protective layer 24 is generally formed of magnesium oxide (MgO).

In the conventional PDP described above, the amount of visible light emitted to the upper substrate 20 from the discharge cells 14 is limited by the first and second sustain electrodes 21a and 21b. If the first and second sustain electrodes 21a and 21b are disposed closer to the barrier ribs 13 to solve this problem, the distance between the first and second sustain electrodes 21a and 21b increases, thereby increasing the discharge voltage. Additionally, to display a high quality image, the volume of the discharge cells 14 should be decreased. However, in the PDP constructed as described above, reducing discharge cell volume may cause poor discharge.

### SUMMARY OF THE INVENTION

The present invention provides a PDP with an improved structure that is capable of producing a high quality image while enhancing brightness and luminous efficiency.

Additional features of the invention will be set forth in the description which follows, and in part will be apparent from the description, or may be learned by practice of the invention.

The present invention discloses a PDP including a first substrate and a second substrate facing each other with a discharge space therebetween and a plurality of barrier ribs partitioning the discharge space to form a plurality of discharge cells. A plurality of address electrodes is arranged on the first substrate, and a first dielectric layer is arranged on the address electrodes. A plurality of first sustain electrodes and a plurality of second sustain electrodes are arranged between the second substrate and the barrier ribs to cause a surface discharge inside the discharge cells, and the first sustain electrodes and the second sustain electrodes are arranged at locations corresponding to locations of the barrier ribs. A second dielectric layer covers at least a surface of the first and second sustain electrodes, and a phosphor layer is arranged in the discharge cells.

The present invention also discloses a PDP including a first substrate and a second substrate facing each other with a discharge space therebetween and a plurality of lower barrier ribs and a plurality of upper barrier ribs partition the discharge space to form a plurality of discharge cells. A plurality of address electrodes are arranged on the first substrate, and a first dielectric layer is arranged on the address electrodes. A plurality of first sustain electrodes and a plurality of second sustain electrodes are arranged between the lower barrier ribs and the upper barrier ribs to cause a surface discharge in the discharge cells, and the first sustain electrodes and the second sustain electrodes are arranged at locations corresponding to locations of the lower barrier ribs and the upper barrier ribs. A second dielectric layer covers at least a surface of the first and second sustain electrodes, and a phosphor layer is arranged in the discharge cells.

The present invention also discloses a plasma display panel (PDP) having a plurality of discharge cells that generate plasma discharge. A discharge cell includes an address electrode. A first sustain electrode and a second sustain electrode are arranged along a first side of the discharge cell to cause a first surface discharge in the discharge cell, and a third sustain electrode and a fourth sustain electrode are arranged along a second side of the discharge cell to cause a second surface discharge in the discharge cell. A first connection electrode couples the first sustain electrode and the third sustain electrode together, and a second connection electrode couples the second sustain electrode and the fourth sustain electrode together. The first connection electrode and the second connection electrode cause a first facing discharge in the discharge cell.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a conventional surface discharge PDP.

FIG. 2 is a cross-sectional view of the PDP of FIG. 1.

FIG. 3 is a schematic plan view showing a PDP according to a first exemplary embodiment of the present invention.

FIG. 4 is a perspective view of electrodes arranged on barrier ribs of the PDP of FIG. 3.

FIG. 5 is a cross-sectional view of the PDP of FIG. 3 along line V-V′.

FIG. 6 is a cross-sectional view of the PDP of FIG. 3 along line VI-VI′.

FIG. 7 is a perspective view of electrodes arranged on barrier ribs of a PDP according to a second exemplary embodiment of the present invention.

FIG. 8 is a cross-sectional view of the PDP of FIG. 7.

FIG. 9 is a perspective view of electrodes arranged on barrier ribs of a PDP according to a third exemplary embodiment of the present invention.

FIG. 10 is a cross-sectional view of the PDP of FIG. 9.

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

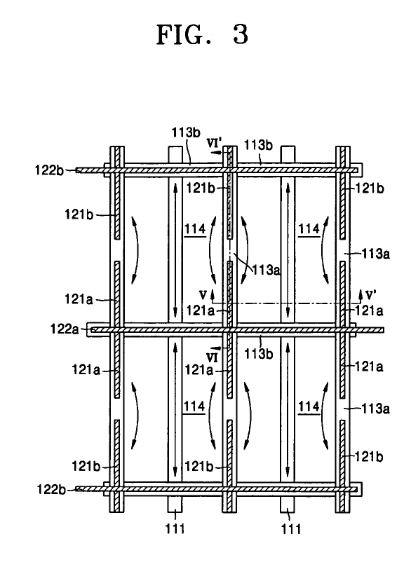

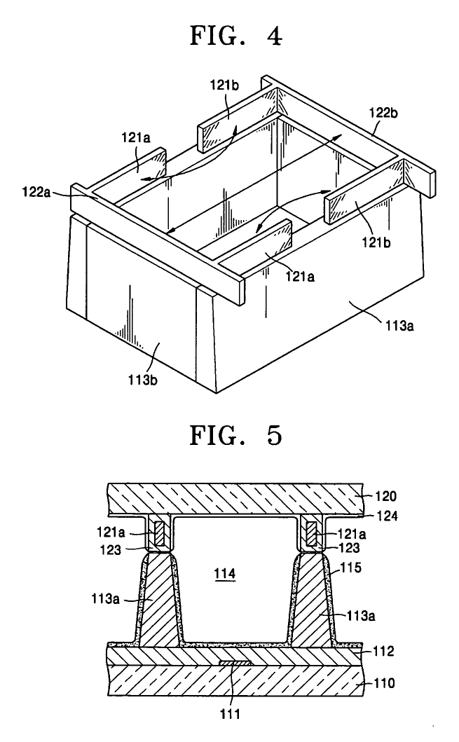

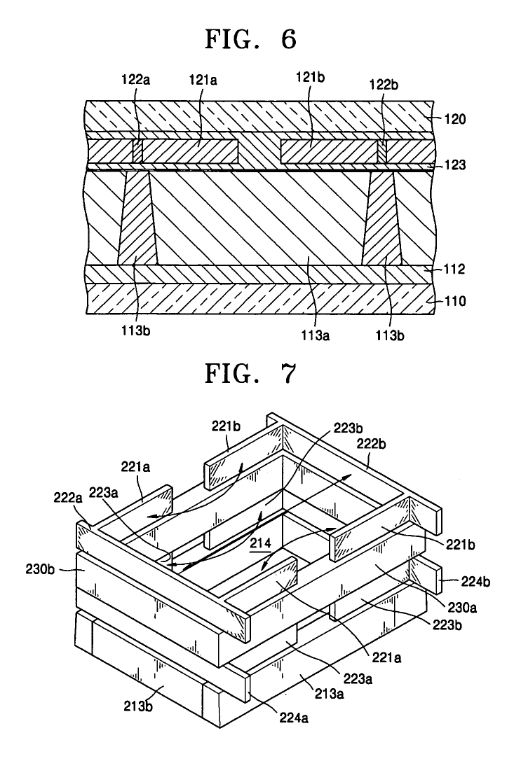

FIG. 3 is a schematic plan view showing a PDP according to a first exemplary embodiment of the present invention, and FIG. 4 is a perspective view of electrodes arranged on barrier ribs of the PDP of FIG. 3. FIG. 5 is a cross-sectional view of the PDP of FIG. 3 along line V-V′, and FIG. 6 is a cross-sectional view of the PDP of FIG. 3 along line VI-VI′.

Referring to FIG. 3, FIG. 4, FIG. 5, and FIG. 6, a first substrate 110, which is a lower substrate, and a second substrate 120, which is an upper substrate, are arranged to face each other with a space therebetween. The first substrate 110 may be a glass substrate. A plurality of address electrodes 111 are arranged parallel to each other on the first substrate 110. A first dielectric layer 112 covers the address electrodes 111. The second substrate 120 may also be a glass substrate.

A plurality of barrier ribs are arranged between the first substrate 110 and the second substrate 120. The barrier ribs form a plurality of discharge cells 114, in which plasma discharge occurs, by partitioning the space between the first substrate 110 and the second substrate 120. The barrier ribs also prevent electrical and optical cross-talk between adjacent discharge cells 114. The barrier ribs include first barrier ribs 113a and second barrier ribs 113b, which are arranged crossing with the first barrier ribs 113a. The first barrier ribs 113a may be formed parallel to the address electrodes 111, and the second barrier ribs 113b may be formed perpendicular to the address electrodes 111.

A discharge gas, which is included in the discharge cells 114, emits ultraviolet light by plasma discharge. The discharge gas may include neon (Ne) gas and xenon (Xe) gas. A phosphor layer 115, which generates red (R), green (G), and blue (B) light, is arranged to a predetermined thickness on the inner walls of the discharge cells 114, that is, on the first dielectric layer 112 and sidewalls of the barrier ribs. The ultraviolet light created by plasma discharge excites the phosphor layer 115, which emits visible light of a predetermined color.

Pairs of first and second sustain electrodes 121a and 121b are arranged between the second substrate 120 and the first barrier ribs 113a. The first and second sustain electrodes 121a and 121b are arranged parallel to the address electrodes 111, and a surface discharge occurs inside the discharge cells 114 by the first and second sustain electrodes 121a and 121b, as indicated by the curved lines between pairs of the first and second sustain electrodes 121a and 121b in FIG. 3 and FIG. 4. First connection electrodes 122a, which electrically couple the first sustain electrodes 121a, and second connection electrodes 122b, which electrically couple the second sustain electrodes 121b, are alternately arranged between the second substrate 120 and the second barrier ribs 113b. The first and second connection electrodes 122a and 122b are arranged on opposite sides of the discharge cells 114, and a facing discharge occurs inside the discharge cells 114 by the connection electrodes 122a and 122b, as indicated by the straight lines between the first and second connection electrodes 122a and 122b in FIG. 3 and FIG. 4. Although the first and second connection electrodes 122a and 122b and the first and second sustain electrodes 121a and 121b are shown with the same height in the drawings, the first and second connection electrodes 122a and 122b may be shorter or taller than the first and second sustain electrodes 121a and 121b. If the first and second connection electrodes 122a and 122b are shorter than the first and second sustain electrodes 121a and 121b, gas may pass through a gap between the first and second connection electrodes 122a and 122b and the second substrate 120, thus facilitating gas exhaust and lowering discharge voltage due to the movement of priming particles during discharge. Conversely, if the first and second connection electrodes 122a and 122b are taller than the first and second sustain electrodes 121a and 121b, the electric field causing the facing discharge may be stronger, thereby lowering the discharge voltage.

A second dielectric layer 123 covers at least a surface of the first and second sustain electrodes 121a and 121b and the first and second connection electrodes 122a and 122b. Although not shown in FIG. 5, the first and second sustain and connection electrodes 121a/b and 122a/b may be arranged directly on the second substrate 120 and/or the barrier ribs 113a/b, respectively. A protective layer 124 is arranged on the second substrate 120 and the second dielectric layer 123. The protective layer 124 prevents damage to the second substrate 120 and the second dielectric layer 123 from sputtering of plasma particles, and it emits secondary electrons, thereby lowering the discharge voltage. The protective layer 24 is generally formed of magnesium oxide (MgO).

In the PDP constructed as described above, address discharge occurs between the address electrode 111 and two of the first sustain electrodes 121a arranged on the adjacent first barrier ribs 113a, or between the address electrode 111 and two of the second sustain electrodes 121b arranged on the adjacent first barrier ribs 113a. Since the address discharge occurs between the address electrode 111 and two of the first or second sustain electrodes 121a or 121b, faster addressing may be possible than in a conventional PDP, and an address discharge voltage may be lowered.

Next, sustain discharge occurs in the selected discharge cells 114. The sustain discharge starts when predetermined voltages are applied to the first and second sustain electrodes 121a and 121b of the adjacent first barrier ribs 113a. The voltages are applied to the first and second sustain electrodes 121a and 121b via the first and second connection electrodes 122a and 122b, respectively. The sustain discharge started in this way occurs as a surface discharge between the first and second sustain electrodes 121a and 121b. A concentrated electric field is created by the first and second sustain electrodes 121a and 121b in the discharge cells 114, thereby smoothly starting the sustain discharge. After starting the sustain discharge, surface discharge occurs between the first and second sustain electrodes 121a and 121b, and facing discharge occurs between the first and second connection electrodes 122a and 122b. Consequently, the discharge cells 114 may have a more concentrated electric field than conventionally, which permits reduction in the sustain discharge voltage. Additionally, as the volume of the discharge cells 114 decreases, the electric field concentration increases. Therefore, the PDP according to the present embodiment may produce a high quality image.

Additionally, in the PDP as described above, a dielectric layer does not need to be formed on the second substrate 120. Hence, the transmittance of visible light generated in the discharge cells 114 may increase, thereby improving the PDP's brightness and luminous efficiency. Furthermore, indium tin oxide (ITO), which has strong electric resistance, need not be formed on the second substrate 120.

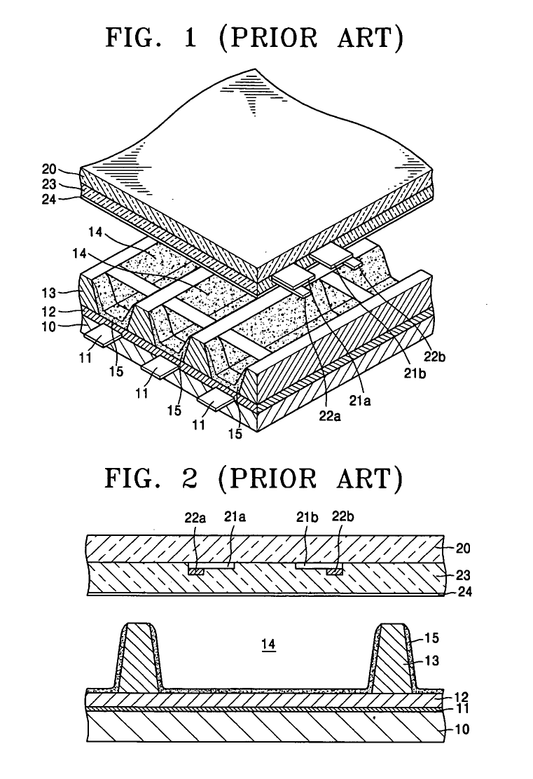

An experiment was conducted to test the luminous efficiency of a conventional PDP of FIG. 1 and a PDP according to the first exemplary embodiment of the present invention as shown in FIG. 3. The PDP according to the first exemplary embodiment of the present invention (when the distance between the pairs of first and second sustain electrodes 121a and 121b was 8 mm) had about a 32% greater luminous efficiency than that of the conventional PDP. Here, a combination of Ne and 5% of Xe was used as the discharge gas in the discharge cells 114, and the pressure of the discharge gas was 10 Torr.

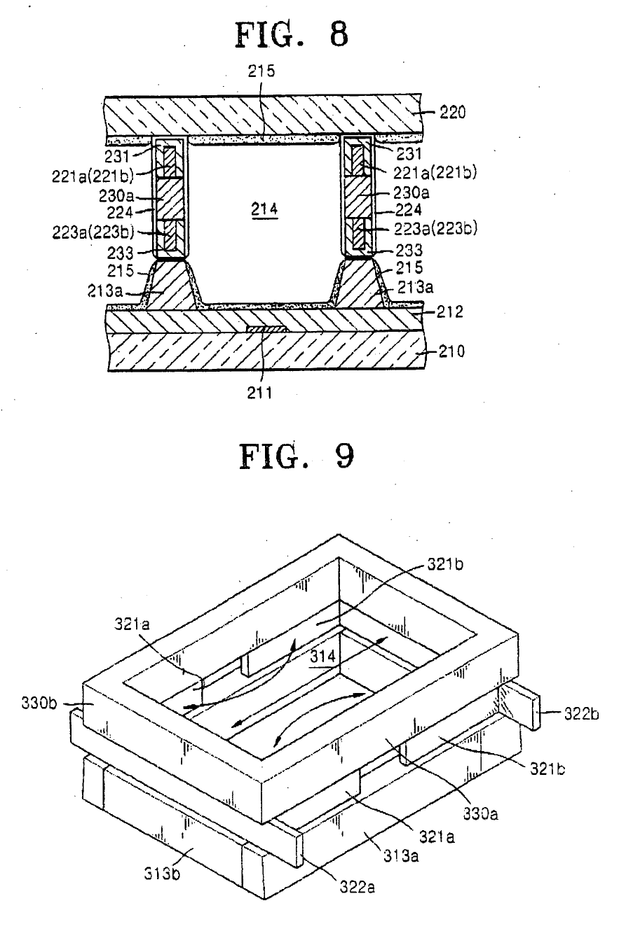

FIG. 7 is a perspective view of electrodes arranged on barrier ribs of a PDP according to a second exemplary embodiment of the present invention, and FIG. 8 is a cross-sectional view of the PDP of FIG. 7. Features of the second exemplary embodiment of the present invention that are different from the first exemplary embodiment of the present invention will be described below.

Referring to FIG. 7 and FIG. 8, a first substrate 210, which is a lower substrate, and a second substrate 220, which is an upper substrate, face each other with a space therebetween. A plurality of address electrodes 211 are arranged parallel to each other on the first substrate 210, and a first dielectric layer 212 covers the address electrodes 211.

A plurality of lower barrier ribs and a plurality of upper barrier ribs, which are vertically separated from each other, are arranged between the first and second substrates 210 and 220. The lower and upper barrier ribs partition a space between the first and second substrates 210 and 220 to form a plurality of discharge cells 214. The lower barrier ribs include first lower barrier ribs 213a and second lower barrier ribs 213b, which are arranged crossing with the first lower barrier ribs 213a. The upper barrier ribs include first upper barrier ribs 230a and second upper barrier ribs 230b, which are arranged crossing with the first upper barrier ribs 230a. The first lower barrier ribs 213a and the first upper barrier ribs 230a may be arranged parallel to the address electrodes 211, and the second lower barrier ribs 213b and the second upper barrier ribs 230b may be arranged perpendicular to the address electrodes 211.

A phosphor layer 215 is formed to a predetermined thickness on the inner walls of the discharge cells 214, that is, on the first dielectric layer 212, the sidewalls of the lower barrier ribs, and the bottom surface of the second substrate 220.

Pairs of first and second sustain electrodes 223a and 223b are arranged along sides of the discharge cells 214 between the first lower barrier ribs 213a and the first upper barrier ribs 230a. Pairs of third and fourth sustain electrodes 221a and 221b are arranged along sides of the discharge cells 214 between the first upper barrier ribs 230a and the second substrate 220. The first and second sustain electrodes 223a and 223b, and the third and fourth sustain electrodes 221a and 221b, are arranged parallel to the address electrodes 211, and surface discharge occurs between the first and second sustain electrodes 223a and 223b and between the third and fourth sustain electrodes 221a and 221b in the discharge cells 214, as indicated by the curved lines between pairs of the first and second sustain electrodes 223a and 223b and between pairs of the third and fourth sustain electrodes 221a and 221b in FIG. 7.

A first connection electrode 224a, which electrically couples the first sustain electrodes 223a, and a second connection electrode 224b, which electrically couples the second sustain electrodes 223b, are alternately arranged between the second lower barrier ribs 213b and the second upper barrier ribs 230b. A third connection electrode 222a, which electrically couples the third sustain electrodes 221a, and a fourth connection electrode 222b, which electrically couples the fourth sustain electrodes 221b, are alternately arranged between the second upper barrier ribs 230b and the second substrate 220. The first and second connection electrodes 224a and 224b, and the third and fourth connection electrodes 222a and 222b, are arranged on opposite sides of the discharge cells 214, and a facing discharge occurs between the first and second connection electrodes 224a and 224b and between the third and fourth connection electrodes 222a and 222b in the discharge cells 214, as indicated by the straight line between the third and fourth connection electrodes 222a and 222b in FIG. 7. The first and second connection electrodes 224a and 224b may be taller or shorter than the first and second sustain electrodes 223a and 223b, similarly to the previous embodiment. Also, the third and fourth connection electrodes 222a and 222b may be taller or shorter than the third and fourth sustain electrodes 221a and 221b.

A second dielectric layer 233 covers at least a surface of the first and second sustain electrodes 223a and 223b and the first and second connection electrodes 224a and 224b. A third dielectric layer 231 covers at least a surface of the third and fourth sustain electrodes 221a and 221b and the third and fourth connection electrodes 222a and 222b. Although not shown in FIG. 8, the first and second sustain and connection electrodes 223a/b and 224a/b may be arranged directly on the lower barrier ribs 213a/b, respectively, and the third and fourth sustain and connection electrodes 221a/b and 222a/b may be arranged directly on the second substrate 220. A protective layer 224 is arranged on the upper barrier ribs, the second and third dielectric layers 233 and 231, and the second substrate 220.

In the PDP constructed as described above, the first and second sustain electrodes 223a and 223b are arranged closer to the address electrodes 211 than in the first exemplary embodiment. Hence, address discharge may occur more easily, which allows for a lower address discharge voltage. Additionally, surface discharge by the first and second sustain electrodes 223a and 223b and surface discharge by the third and fourth sustain electrodes 221a and 221b may initiate sustain discharge even more smoothly. Also, after initiating the sustain discharge, is facing discharge may occur between the first and second connection electrodes 224a and 224b and between the third and fourth connection electrodes 222a and 222b, and thus the sustain discharge voltage may be lowered.

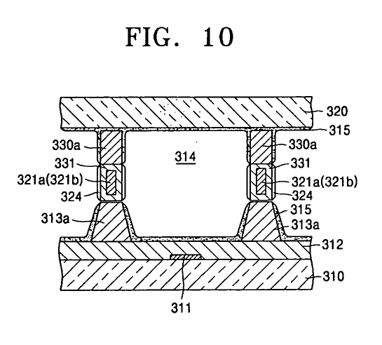

FIG. 9 is a perspective view of electrodes arranged on barrier ribs of a PDP according to a third exemplary embodiment of the present invention, and FIG. 10 is a cross-sectional view of the PDP of FIG. 9. Features of the present exemplary embodiment that are different from those of the first and second exemplary embodiments of the present invention will be described below.

Referring to FIG. 9 and FIG. 10, a first substrate 310, which is a lower substrate, and a second substrate 320, which is an upper substrate, face each other with a plurality of discharge cells 314 therebetween. A plurality of address electrodes 311 are arranged parallel to each other on the first substrate 310, and a first dielectric layer 312 covers the address electrodes 311.

A plurality of lower barrier ribs and a plurality of upper barrier ribs, which are vertically separated from each other, are arranged between the first and second substrates 310 and 320. The lower barrier ribs include first lower barrier ribs 313a, which are arranged parallel to the address electrodes 311, and second lower barrier ribs 313b, which are arranged perpendicular to the address electrodes 311. The upper barrier ribs include first upper barrier ribs 330a, which are arranged parallel to the first lower barrier ribs 313a, and second upper barrier ribs 330b, which are arranged parallel to the second lower barrier ribs 313b. A phosphor layer 315 is formed to a predetermined thickness on the inner walls of the discharge cells 314, that is, on the first dielectric layer 312, the sidewalls of the lower barrier ribs, the second substrate 320, and the sidewalls of the upper barrier ribs.

Pairs of first and second sustain electrodes 321a and 321b are arranged along sides of the discharge cells 314 between the first lower barrier ribs 313a and the first upper barrier ribs 330a. The first and second sustain electrodes 321a and 321b are arranged parallel to the address electrodes 311, and a surface discharge occurs between the first and second sustain electrodes 321a and 321b in the discharge cells 314, as indicated by the curved lines between pairs of the first and second sustain electrodes 321a and 321b in FIG. 9. A first connection electrode 322a, which electrically couples the first sustain electrodes 321a, and a second connection electrode 322b, which electrically couples the second sustain electrodes 321b, are alternately arranged between the second lower barrier ribs 313b and the second upper barrier ribs 330b. The first and second connection electrodes 322a and 322b are arranged on opposite sides of the discharge cells 314, and a facing discharge occurs between the first and second connection electrodes 322a and 322b in the discharge cells 314, as indicated by the straight line between the first and second connection electrodes 322a and 322b in FIG. 9. The first and second connection electrodes 322a and 322b may be taller or shorter than the first and second sustain electrodes 321a and 321b, as in the previous exemplary embodiments. A second dielectric layer 331 covers at least a surface of the first and second sustain electrodes 321a and 321b. Although not shown in FIG. 10, the first and second sustain and connection electrodes 321a/b and 322a/b may be arranged directly on the lower and/or upper barrier ribs 313a/b and 330a/b, respectively. A protective layer 324 is arranged on the second dielectric layer 331.

In the PDPs of the first through third exemplary embodiments, the first substrates 110, 210, and 310, on which the address electrodes 111, 211, and 311 are formed, are lower substrates, and the second substrates 120, 220, and 230 are upper substrates. However, as an alternative, a first substrate, on which address electrodes are formed, may be an upper substrate, and a second substrate may be a lower substrate.

In a PDP according to exemplary embodiments of the present invention, the following effects may be obtained.

First, quick address discharge may occur between address electrodes and sustain electrodes, thereby lowering the address discharge voltage.

Second, an electric field generated by the sustain electrodes and connection electrodes is concentrated inside discharge cells, thereby lowering the sustain discharge voltage. Additionally, as the volume of the discharge cells decreases, the electric field becomes increasingly concentrated in the discharge cells, and thus a high quality image may be produced more easily.

Third, initially, a discharge starts as a surface discharge caused by the sustain electrodes formed on first barrier ribs, and then becomes a facing discharge caused by the connection electrodes formed on second barrier ribs.

Fourth, the sustain electrodes and the connection electrodes are arranged on barrier ribs, and a dielectric layer does not need to be formed on the upper substrate, which may increase the transmittance of visible light generated by the discharge cells. Accordingly, the PDP's brightness and luminous efficiency may improve. Also, materials with high electric resistance, such as ITO, do not need to be formed on the second substrate.

Fifth, since the electric field may be more uniformly formed inside the discharge cells, ultraviolet light generated by the discharge may be more uniformly transmitted to a phosphor layer, thereby improving brightness and luminous efficiency.

It will be apparent to those skilled in the art that various modifications and variation can be made in the present invention without departing from the spirit or scope of the is invention. Thus, it is intended that the present invention cover the modifications and variations of this invention provided they come within the scope of the appended claims and their equivalents.

What is claimed is:

1. A plasma display panel (PDP), comprising:
a first substrate and a second substrate facing each other with a discharge space therebetween;
a plurality of barrier ribs partitioning the discharge space to form a plurality of discharge cells;
a plurality of address electrodes arranged on the first substrate;
a first dielectric layer on the address electrodes;
a plurality of first sustain electrodes and a plurality of second sustain electrodes arranged between the second substrate and the barrier ribs to cause a surface discharge in the discharge cells, the first sustain electrodes and the second sustain electrodes being arranged at locations corresponding to locations of the barrier ribs;
a second dielectric layer which covers at least a surface of the first sustain electrodes and the second sustain electrodes; and
a phosphor layer arranged in the discharge cells.

2. The PDP of claim 1, wherein the barrier ribs comprise:
first barrier ribs; and
second barrier ribs arranged crossing with the first barrier ribs,
wherein the first sustain electrodes and the second sustain electrodes are arranged at locations corresponding to locations of one of the first barrier ribs and the second barrier ribs.

3. The PDP of claim 2, wherein the first barrier ribs are arranged parallel to the address electrodes, the second barrier ribs are arranged perpendicular to the address electrodes, and the first sustain electrodes and the second sustain electrodes are arranged at locations corresponding to the locations of the first barrier ribs.

4. The PDP of claim 3, further comprising:
first connection electrodes coupling the first sustain electrodes together; and
second connection electrodes coupling the second sustain electrodes together,
wherein the first connection electrodes and the second connection electrodes are alternately arranged at locations corresponding to the locations of the second barrier ribs.

5. The PDP of claim 1, further comprising:
a protective layer arranged on the second substrate and the second dielectric layer.

6. The PDP of claim 1, wherein the first sustain electrodes and the second sustain electrodes are arranged directly on at least one of the second substrate and the barrier ribs.

7. A plasma display panel (PDP), comprising:
a first substrate and a second substrate facing each other with a discharge space therebetween;
a plurality of lower barrier ribs;
a plurality of upper barrier ribs arranged on the lower barrier ribs, the lower barrier ribs and the upper barrier ribs partitioning the discharge space to form a plurality of discharge cells;
a plurality of address electrodes arranged on the first substrate;
a first dielectric layer on the address electrodes;
a plurality of first sustain electrodes and a plurality of second sustain electrodes arranged between the lower barrier ribs and the upper barrier ribs to cause a surface discharge in the discharge cells, the first sustain electrodes and the second sustain electrodes being arranged at locations corresponding to locations of the lower barrier ribs and the upper barrier ribs;
a second dielectric layer which covers at least a surface of the first sustain electrodes and the second sustain electrodes; and
a phosphor layer arranged in the discharge cells.

8. The PDP of claim 7, wherein
the lower barrier ribs comprise:
first lower barrier ribs; and
second lower barrier ribs arranged crossing with the first lower barrier ribs; and
the upper barrier ribs comprise:
first upper barrier ribs; and
second upper barrier ribs arranged crossing with the first upper barrier ribs,
wherein the first sustain electrodes and the second sustain electrodes are arranged at locations corresponding to either locations of the first lower barrier ribs and the first upper barrier ribs or locations of the second lower barrier ribs and the second upper barrier ribs.

9. The PDP of claim 8, wherein the first lower barrier ribs and the first upper barrier ribs are arranged parallel to the address electrodes, the second lower barrier ribs and the second upper barrier ribs are arranged perpendicular to the address electrodes, and the first sustain electrodes and the second sustain electrodes are arranged at locations corresponding to the locations of the first lower barrier ribs and the first upper barrier ribs.

10. The PDP of claim 9, further comprising:
first connection electrodes coupling the first sustain electrodes together; and
second connection electrodes coupling the second sustain electrodes together,
wherein the first connection electrodes and the second connection electrodes are alternately arranged at locations corresponding to the locations of the second lower barrier ribs and the second upper barrier ribs.

11. The PDP of claim 7, further comprising:
a protective layer arranged on the second dielectric layer.

12. The PDP of claim 7, wherein the first sustain electrodes and the second sustain electrodes are arranged directly on at least one of the lower barrier ribs and the upper barrier ribs.

13. The PDP of claim 7, further comprising:
a plurality of third sustain electrodes and a plurality of fourth sustain electrodes arranged between the second substrate and the upper barrier ribs to cause a surface discharge in the discharge cells; and
a third dielectric layer which covers at least a surface of the third sustain electrodes and the fourth sustain electrodes.

14. The PDP of claim 13, wherein the upper barrier ribs comprise:
first upper barrier ribs; and
second upper barrier ribs arranged crossing with the first upper barrier ribs, and
the third sustain electrodes and the fourth sustain electrodes are arranged at locations corresponding to locations of one of the first upper barrier ribs and the second upper barrier ribs.

15. The PDP of claim 14, wherein the first upper barrier ribs are arranged parallel to the address electrodes, the second upper barrier ribs are arranged perpendicular to the address electrodes, and the third sustain electrodes and the fourth sustain electrodes are arranged at locations corresponding to the locations of the first upper barrier ribs.

16. The PDP of claim 15, further comprising:
third connection electrodes coupling the third sustain electrodes together; and
fourth connection electrodes coupling the fourth sustain electrodes together,
wherein the third connection electrodes and the fourth connection electrodes are alternately arranged at locations corresponding to the locations of the second upper barrier ribs.

17. The PDP of claim 13, further comprising:
a protective layer arranged on the third dielectric layer.

18. The PDP of claim 13, wherein the third sustain electrodes and the fourth sustain electrodes are arranged directly on at least one of the second substrate and the upper barrier ribs.

19. A plasma display panel (PDP) comprising a plurality of discharge cells to generate plasma discharge, a discharge cell comprising:
an address electrode;
a first sustain electrode and a second sustain electrode arranged along a first side of the discharge cell to cause a first surface discharge in the discharge cell;
a third sustain electrode and a fourth sustain electrode arranged along a second side of the discharge cell to cause a second surface discharge in the discharge cell;
a first connection electrode coupling the first sustain electrode and the third sustain electrode together;
a second connection electrode coupling the second sustain electrode and the fourth sustain electrode together, the first connection electrode and the second connection electrode to cause a first facing discharge in the discharge cell.

20. The PDP of claim 19, wherein the first sustain electrode, the second sustain electrode, the third sustain electrode, and the fourth sustain electrode are arranged parallel to the address electrode, and the first connection electrode and the second connection electrode are arranged perpendicular to the address electrode.

21. The PDP of claim 19, further comprising:
a fifth sustain electrode and a sixth sustain electrode arranged along the first side of the discharge cell to cause a third surface discharge in the discharge cell;
a seventh sustain electrode and an eighth sustain electrode arranged along the second side of the discharge cell to cause a fourth surface discharge in the discharge cell;
a third connection electrode coupling the fifth sustain electrode and the seventh sustain electrode together;
a fourth connection electrode coupling the sixth sustain electrode and the eighth sustain electrode together, the third connection electrode and the fourth connection electrode to cause a second facing discharge in the discharge cell.

22. The PDP of claim 21, wherein the first sustain electrode, the second sustain electrode, the third sustain electrode, the fourth sustain electrode, the fifth sustain electrode, the sixth sustain electrode, the seventh sustain electrode, and the eighth sustain electrode are arranged parallel to the address electrode, and the first connection electrode, the second connection electrode, the third connection electrode, and the fourth connection electrode are arranged perpendicular to the address electrode.

23. The PDP of claim 19, further comprising:
first barrier ribs arranged parallel to the address electrode; and
second barrier ribs arranged perpendicular to the address electrode,
wherein the first sustain electrode, the second sustain electrode, the third sustain electrode, and the fourth sustain electrode are arranged at locations corresponding to locations of the first barrier ribs, and the first connection electrode and the second connection electrode are arranged at locations corresponding to locations of the second barrier ribs.
